(19) United States
(12) Patent Application Publication
(10) Pub. No.: US 2009/0321354 A1
(43) Pub. Date: Dec. 31, 2009

(54) Membrane Reactor for the Treatment of Liquid Effluents, Comprising a Membrane for Diffusion of an Oxidizing Gas and a Selective Membrane Defining a Reaction Space Between Said Membranes

(75) Inventors: Samuel Heng, Villetaneuse (FR); King Lun Yeung, Hong Kong (CN); Jean-Christophe Schrotter, Maisons-Laffite (FR)

Correspondence Address: COATS & BENNETT, PLLC, 1400 Crescent Green, Suite 300, Cary, NC, 27518, US

(73) Assignee: OTV SA, Saint-Maurice Cedex (FR)

(21) Appl. No.: 12/375,732

(22) PCT Filed: Jul. 25, 2007
(86) PCT No.: PCT/EP2007/057683

§ 371 Date: Apr. 3, 2009

(30) Foreign Application Priority Data
Aug. 1, 2006 (FR) 06/07046

(51) Int. Cl. B01D 61/16; C02F 1/72; C02F 1/44; B01D 61/18

(52) U.S. Cl. 210/638; 210/151

(57) ABSTRACT

The subject of the invention is a membrane reactor for the treatment of liquid effluents containing organic pollutants, of the type comprising at least one porous membrane (3) for the diffusion of an oxidizing gas, characterized in that it includes at least one selective membrane (2), (4) of said pollutants, which selective membrane defines, with said porous membrane for the diffusion of an oxidizing gas, a reaction space (31) into which said liquid effluents are injected, said reactor having means (34) for extracting retentates from said reaction space (31) and a space (32) for recovering the treated effluents, which space is separated from said reaction space (31) by said selective membrane or membranes (2), (4).

The field of the invention is that of the treatment of liquid effluents. More specifically, the invention relates to a membrane reactor used in particular, but not exclusively, to treat liquid effluents containing organic pollutants that are difficult to biodegrade or non-biodegradable by an oxidation process alone (e.g. ozonation).

Currently, the treatment of liquid effluents containing organic compounds is primarily performed by biological systems.

These systems have the disadvantage of generating secondary waste in the form of sludge.

In spite of this, the biological treatment is often preferred over other processes because it is less expensive.

However, when toxic or non-biodegradable compounds are present in the effluents to be treated, the biological treatment becomes complex and even impossible.

Depending on the concentration and the physicochemical properties of the organic pollutants in question, a plurality of substitution systems are possible, including:
incineration;
stripping;
adsorption;
filtration;
chemical oxidation.

Incineration can be envisaged only in the specific case in which the organic effluents are highly concentrated and has a sufficiently high heating value. However, incineration remains a particularly expensive process because it requires a high-temperature (>900° C.) furnace coupled with a battery of fumes (COV, NO_{X}, SO_{X}) treatment process for treating fumes generating additional secondary waste.

Stripping is possible only if the organic pollutants are sufficiently concentrated and have a suitable Henry constant enabling their washout by a gas flux. In the end, a gas treatment process is therefore necessary, which tends to complicate the corresponding process and, consequently, increase operating costs.

Adsorption is a solution that is easy to implement. However, this process has the disadvantage of generating secondary solid waste that must then be incinerated, then sent to a special industrial waste storage site. In the end, this solution is therefore costly.

Depending on the type of pollutants, the membrane filtration processes, such as microfiltration, ultrafiltration, nanofiltration or reverse osmosis are capable of separating the solid compounds and other water-soluble compounds with good efficacy. Aside from the fact that these processes are relatively costly, they have the disadvantage of concentrating and not destroying the pollutants. Indeed, they are accumulated during filtration and must then undergo additional treatments.

Consequently, chemical oxidation processes therefore appear to be the best existing solution for destroying organic, non-biodegradable compounds.

Among the chemical oxidation processes, the free radical reactions initiated by the OH° radicals such as: O₃, H₂O₂, O₃+UV, H₂O₂+O₃ and TIO₂+UV are the most interesting.

Among the existing reagents, ozone stands out, as it is less expensive and less constricting than peroxide (H₂O₂).

Indeed, ozone can be produced on site as needed and does not require any storage.

Moreover, ozonation is already commonly used in the field of water treatment for disinfecting drinking water. Its use in the treatment of industrial water is gradually increasing, in particular for oxidation of organic, non-biodegradable compounds.

However, ozone remains relatively ineffective for reduction and total mineralization of organic compounds.

Indeed, due to the low solubility of ozone in the aqueous phases, the ozonation of organic compounds does not always result in total mineralization of source pollutants. A certain number of intermediate degradation byproducts are therefore formed during ozonation. These reaction byproducts, of which the toxicity is not yet known, must therefore undergo additional treatments as a precaution.

Typically, adsorption, filtration and/or biological treatment steps can complement an ozonation process.

However, these complementary treatments increase the complexity of the processes and therefore also their operating costs.

In addition, to improve the reduction of organic, non-biodegradable compounds by ozone, the use of heterogeneous catalysts and/or adsorbents in grain or powder form are often used.

However, the use of these heterogeneous compounds creates a subsequent step of filtration or physicochemical separation in order to recover them.

Typically, ozonation is performed in a batch or bubble column reactor with porous diffusers or an injector. Ozonation is used in pre- or post-treatment to reduce the organic compounds or in order to enhance their biodegradability.

The processes using ozone generally consist of a plurality of independent and distinct steps, such as, for example, adsorption, filtration and/or biological treatment.

When the oxidizing gas is used in the presence of ozone-resistant filtration membranes, the introduction thereof is performed upstream or optionally simultaneously. It should be noted that ozone is then used as a cleaning agent, and is intended to limit the clogging of the membranes.

Indeed, the bubbles and hydrodynamics created by them are favorable to unclogging and degradation of the fouling layer.

It has also been proposed in the prior art to combine a filtration process with an oxidation reaction (catalytic or not). This is described by patent documents FR-2 861 718 and WO-2005 047 191, which present a process and an installation using immersed membranes for water treatment. The continuous reactor contains catalysts and/or adsorbents in the form of a fluidized bed. The ozone is introduced into the reactor from the bottom of it via the use of a porous diffuser. A separating membrane is used to retain the catalytic or adsorbent materials in the reactor.

According to another technique, described in the document of Takizawa, “Membrane fouling decrease by microfiltration with ozone scrubbing” (DESALINATION, ELSEVIER, AMSTERDAM, NL, vol. 106, no. 1, August 1996, pages 423-426), the declogging power of ozone on filtration membranes used in a potable water production process is studied. For this, a reactor integrates, in its lower part, ozone diffusion means, and, in its upper part, selective membranes.

In these two techniques, the reactor defines a single chamber integrating effluent oxidation and filtration treatments. In other words, the oxidation and filtration steps are performed in the same volume.

In practice, it is noted that the separation membrane does not enable the compounds to be selectively concentrated, and the reactor does not create synergy between the oxidation and the separation. In general, this technique does not enable the reduction of the Total Organic Carbon (TOC) to be improved.

Other effluent treatment techniques have been proposed in the prior art.

The patent document published under number U.S. Pat. No. 5,580,452 describes a device for selective transport of permeate using a fluid, integrating membrane modules.

According to this technique, membrane elements each include two hollow tubular fibers. One of the hollow fibers of each element is inserted into the other of the hollow fibers, with an annular space extending between the two hollow fibers. A circulating liquid membrane system is created by passing a selective permeability liquid through the annular spaces. The supply fluid flows through the central holes. The discharge fluid flows over the outer surface of the hollow outer fibers. When the supply fluid passes into the inner tube, the permeate is separated from the supply fluid and is transferred through the selective permeability liquid toward the discharge fluid. The passage of the permeate into the discharge fluid is achieved by the difference in chemical potential through the selective permeability liquid. Hollow fibers placed at the interface between the supply fluid and the selective permeability fluid can be formed by a polymer, metal or ceramic material. The hollow fiber at the interface between the selective permeability liquid or the discharge liquid can be hydrophobic or hydrophilic and can, with a view to a selective gas separation, include a cobalt-based material in order to separate the oxygen from the air.

However, this technique does not involve injecting (in particular into the central hole) a strong oxidizing agent capable of oxidizing the pollutants. Moreover, the porous fiber at the interface between the fluid to be treated and the selective permeability liquid does not constitute a selective membrane. Such a technique does not therefore enable:
the polluting compounds to be selectively concentrated;
the oxidation and separation steps to be combined.

The prior art also includes a technique, described by the document published under number U.S. Pat. No. 4,750,918, for separating gaseous phases by selective permeability. The device implemented according to this technique includes a transfer chamber into which a liquid to be treated is introduced, and hollow gas enrichment fibers and hollow gas reduction fibers extending through the transfer chamber. The gas circulation inside the fibers occurs in the direction opposite the gas circulation outside the fibers. The countercurrent circulation of gas in the fibers ensures a transfer of gaseous phases between the liquid present in the transfer chamber and the hollow fibers.

However, this technique is limited to exchanges between gaseous phases.

The invention is intended in particular to overcome the disadvantages of the prior art.

More specifically, the invention aims to propose a membrane reactor that is more efficient than the reactors of the prior art.

In this sense, the invention aims to provide such a reactor that enables better TOC reduction to be obtained.

The invention also aims to provide such a reactor that enables operating costs, in particular in terms of oxidizing gas consumption, to be reduced.

The invention also aims to provide such a reactor with a simple design, low bulk and which is inexpensive to operate.

Another objective of the invention is to provide such a reactor that is particularly less subject to clogging phenomena than the known reactors.

These objectives as well as others, which will appear below, are achieved by the invention, which relates to a membrane reactor for treating liquid effluents containing organic pollutants, of the type including at least one porous membrane for diffusion of an oxidizing gas, characterized in that it includes at least one membrane selective for said pollutants defining, with said porous membrane for diffusion of an oxidizing gas, a reaction space into which said liquid effluents are injected, which reactor has means for extracting retentate from said reaction space and a treated effluent recovery space separated from said reaction space by said selective membrane(s).

Due to its particular configuration, the invention makes it possible to combine an oxidation reaction and a separation reaction in the same confined module serving as a reactor. This double membrane reactor concept simultaneously enables;
the production of clean water;
the production of a treated biodegradable effluent;
optimization of the rate of ozone transfer from the gas phase to the liquid phase;
an increase in the efficacy and kinetics of the oxidation reaction.

Indeed, the coupling of the oxidation reaction and the membrane separation allows for a significant improvement in the rate of reduction of organic compounds in solution with respect to a classic reactor.

Moreover, the use of ozone with an in situ membrane process also enables the clogging of membranes to be reduced, as already reported elsewhere.

It is noted that the invention enables the oxidation reaction to be optimized, in particular owing to:
increased oxidizing gas transfer with respect to the large surface-volume of the contactor formed by the selective membrane;
diffusion of the oxidizing gas directly into the reaction area (less intermediate reaction);
homogeneous mixing and diffusion;
control of the oxidation dose and time.

The invention also allows for other advantages, including:
simplicity of the installation (a single module combining oxidation and separation reactions);
low installation cost;
low installation bulk;
a reduction in the reaction time and therefore the ozone consumption;
efficiency for energy cost at least as good as classic methods;
production of filtered water not containing potentially toxic intermediate organic compounds;
production of treated water containing biodegradable organic compounds.

It is noted, contrary to the techniques described by documents FR-2 861 718 and “Membrane fouling decrease by microfiltration with ozone scrubbing” cited above in reference to the prior art, the reactor according to the invention integrates a compartmentalization enabling the treatment, and, in particular, the TOC reduction, to be optimized.

Indeed, the porous membrane and the selective membrane together define a closed space (with the exception of means for injecting the effluents and means for extracting the retentate produced by the selective membrane). The oxidation reaction takes place in this space in a confined manner in the vicinity of the selective membrane, which causes synergy between the separation and oxidation and a more effective reaction owing to the rapid discharge of the treated effluents (permeate). This synergy involves an acceleration in the reaction, followed by a rapid discharge of the retentate.

In addition, another space, separated from the reaction space, is obtained by compartmentalization of the reactor: the treated effluent recovery space. For this, the selective membrane(s) form(s) a partition between the reaction space and said recovery space.

In other words, a reactor according to the invention is defined as a membrane reactor for treating liquid effluents containing organic pollutants, including at least one porous oxidizing gas diffusion membrane, including:
a first compartment of which a first partition is formed by said porous membrane and a second partition is formed by at least one selective membrane through which said effluents are intended to circulate, means for injecting said effluents leading into said first compartment and means for extracting the pollutant retentate, retained by said selective membrane(s), extending from said first compartment, with said first compartment forming a reaction space advantageously confined directly in the vicinity of said selective membrane(s);
a second compartment separated form said first compartment by said second partition, which second compartment forms a treated effluent recovery space.

According to a first embodiment, said porous membrane for diffusion of an oxidizing gas defines a first closed perimeter, inside of which said selective membrane(s) itself (or themselves) define a second closed perimeter.

According to a second embodiment, said porous membrane for diffusion of an oxidizing gas defines a first closed perimeter, outside of which said selective membrane(s) itself (or themselves) define a second closed perimeter.

According to a preferred solution, said porous membrane for diffusion of an oxidizing gas and said selective membrane(s) are substantially cylindrical and concentric, and form three compartments constituting a base module.

According to a possible alternative, said porous membrane for diffusion of an oxidizing gas and said selective membrane(s) are substantially planar, and parallel, and form three compartments constituting a base module.

The invention is not limited to such a configuration, as the two membranes can, according to other possible embodiments, be perpendicular to one another, or be constituted by planar membranes, hollow fibers, or cylindrical, multichannel or spiral membranes.

According to a preferred embodiment, said porous membrane for diffusion of an oxidizing gas and said selective membrane(s) extend substantially vertically.

Thus, good circulation and optional recycling of the oxidizing gas are ensured.

The rising of small bubbles also ensures the mixing, transfer and reaction of the oxidizing gas with the liquid phase.

Preferably, said porous membrane for diffusion of an oxidizing gas is a porous ozone diffusion membrane.

It is noted that the oxidizing gas can, according to other possible embodiments, be:
air, oxygen or a mixture;
an injection of liquid product such as peroxide or sodium persulfate.

Advantageously, said selective membrane(s) belong(s) to the following group:
pervaporation membranes;
ultrafiltration or microfiltration membranes
nanofiltration membranes;
reverse osmosis membranes.

According to a first embodiment, said selective membrane(s) is (are) inert, for example, based on metal, ceramic or organic ozone-resistant materials.

According to a second embodiment, said selective membrane(s) is (are) active.

The performance of the reactor can thus be further improved.

In this case, according to a first alternative, said selective membrane(s) and/or said oxidizing gas diffusion membrane(s) include(s) at least one layer of an adsorbent material, advantageously belonging to the following group:
active carbon;
any other inorganic or adsorbent clay material, preferably hydrotalcite or activated alumina.

According to a second alternative, said selective membrane(s) include(s) at least one layer of a catalyst, advantageously belonging to the following group:
metals;
metal oxides.

According to another possible alternative, an adsorbent material and/or a catalyst are present in the form of a bed in said reaction space.

According to another feature, the membrane reactor includes means for recycling said oxidizing gas present in excess in said reaction space.

According to a first possible configuration, the reactor includes a plurality of base modules installed in series.

According to a second possible configuration, the reactor includes a plurality of base modules installed in parallel.

Other features and advantages of the invention will become clearer on reading the following description of a preferred embodiment of the invention, given by way of an illustrative and non-limiting example, and the appended drawings in which:

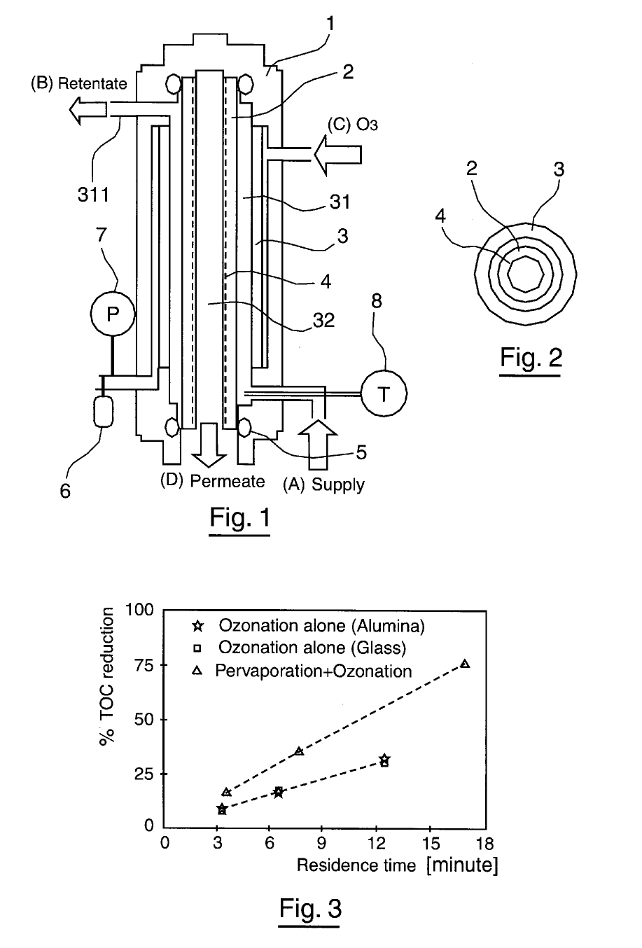

FIG. 1 is a diagrammatic longitudinal cross-section view of a reactor according to the invention;

FIG. 2 is a diagrammatic transverse cross-section view of the membranes of a reactor according to the invention;

FIG. 3 is a graph showing the benefit of a reactor according to the invention with respect to simple ozonation.

As described above, the principle of the invention lies in the integration, in a liquid effluent treatment reactor, of two membranes, one for diffusion of an oxidizing gas such as ozone, and the other for separation of organic pollutants from the effluents.

A preferred embodiment of the invention is shown in FIGS. 1 and 2.

As shown, the reactor integrates two concentric (or non-concentric) porous membranes; the first serves to diffuse gaseous ozone 3 in an aqueous medium, and the second 2, 4 serves to separate the water.

It is noted that the membranes together define three compartments (one for ozone, one for the water to be treated (and the retentate), and the last for the permeate), constituting a base module.

The reactor can integrate a plurality of these base modules, arranged in series or in parallel.

The membranes 2, 4 and 3 mutually define a reaction space 31 into which the effluents to be treated is injected by a supply A, with the treated effluents D being recovered from a space 32 separated from the reaction space 31 by the membrane 2, 4.

In addition, a duct 34 communicates with the space 31 in order to enable the extraction of the retentate.

It is therefore understood that the invention involves designing a compartmentalized membrane reactor.

Indeed, the reaction space 31 forms a first compartment, of which one partition is formed by the ozone diffusion membrane 3, and another partition is formed by the selective membrane 2, 4 (the ozone diffusion membrane and the selective membrane extend between reactor wall portions, in this case in upper and lower portions of the reactor, which reactor wall portions consequently connect the ozone diffusion membrane and the selective membrane to form a closed space).

Leading into this first compartment are means A for injecting effluents and retentate (constituted by the pollutant material retained by the selective membrane) extracted from said first compartment. Of course, the ozone diffusion membrane provides the ozone diffusion in this first compartment.

It is noted that this compartment forms a confined reaction space, with the ozone diffusion membrane being positioned with respect to the selective membrane so that the oxidation reaction takes place integrally, or almost directly in the vicinity of the selective membrane, in order to obtain the desired synergy between the oxidation and separation steps.

In addition, the reactor has a second compartment, separated from the first compartment by the partition formed by the selective membrane.

It is understood that the effluents circulate from the first compartment to the second compartment by passing through the selective membrane, and that the effluents treated are recovered from this second compartment.

This configuration as a whole enables an improvement and optimization of the ozone transfer rate due to the much larger surface-to-volume ratio than in a classic reactor.

As shown clearly in FIG. 2, membrane 3 and membrane 2, 4 are, according to this embodiment, cylindrical and concentric, with membrane 3 defining a closed perimeter inside of which membrane 2, 4 extends, with the latter itself defining a closed perimeter defining the permeate recovery space 32.

It is noted that, according to another possible configuration, membrane 3 defines a closed perimeter and membrane 2, 4 extends outside of the perimeter of membrane 3 while itself defining a closed perimeter.

In addition, the coupling of the action of the two membranes in the same module, i.e. the gaseous ozone diffusion coupled with a separation, produces a synergistic effect between the transfer and the ozone consumption. Indeed, the concentration of organic compounds in the reaction space 31, on the supply side, in the space confined between the two membranes 3 and 2, 4, enables not only an increase in the ozone transfer factor but also increased reaction kinetics with respect to a classic reactor without this coupling.

The cylindrical reactor is positioned vertically.

The membrane 2, 4 can be inert.

However, the performance of the membrane reactor can be improved by adding a layer 2 of material, such as an adsorbent (active carbon, active alumina, hydrocalcite and other inorganic or clay materials) or catalysts (metal or metal oxides) in the form of a bed in the reaction zone, and/or by grafting or coating the latter on a selective or non-selective membrane (therefore on membrane 3 and/or 2, 4), serving as a contactor. This contactor can be made of polymer ceramic or porous metal.

The selective pervaporation, ultrafiltration, microfiltration, nanofiltration or reverse osmosis membrane 2, 4 is resistant to ozone. The presence of a selective membrane enables both a considerable improvement in the efficacy of the ozone in reducing the organic compounds in solution and also the production of clean water not containing organic ozonation-intermediate compounds.

The diffusion of ozone from the gaseous phase to the aqueous phase can be ensured by the use of a porous membrane, polymer, steel or porous ceramic diffuser, injector or static contactor, in a bubble column or in a closed basin.

Various types of materials can serve as ozone diffusers.

For example, U.S. Pat. No. 5,645,727 A presents a process for producing ultra-pure water with the use of a ceramic contactor.

According to another technique, described by Mitani et al. (Mass transfer of ozone—a microporous diffuser reactor system. Ozone Sc. Eng. 27 (2005) 45-51), a cylindrical microporous steel membrane is placed at the center of a column. It is demonstrated that the ozone transfer rate is significantly higher than with classic methods.

According to another technique, described by R. H. S. Jansen, J. W. de Rijj, A. Zwijnenburg, M. H. V. Mulder, and M. Wessling (Hollow fiber membrane contactors—A means to study the reaction kinetics of humic substance ozonation. J. Memb. Sci. 257 (2005) 48-59), hollow PVDF fibers are placed in a steel module and serve as an ozone contactor.

According to yet another technique, described by Janknecht et al. (Ozone-water contacting by ceramic membranes. Separation and Purification Technology, 25 (2001) 341-346), ceramic membranes are used to diffuse ozone in a tubular reactor, effectively and with an energy consumption comparable to other gas diffusion methods.

It is noted that, according to the embodiment shown in FIG. 1, the ozone is injected by means of a valve 6 coupled to a pressure gauge 7.

In addition, the reactor is equipped with means for detecting an excess of ozone in the reactor and means for recovering/recycling the excess ozone.

Furthermore, the supply duct is equipped with means 8 for measuring a thermocouple, enabling the temperature of the fluid to be treated to be measured.

The reactor shown in FIG. 1 and described above has been implemented in order to show the advantages provided by the oxidation/separation coupling concept of this invention.

To conduct the tests, a selective zeolite membrane on a ceramic support was used as a separator in order to concentrate the organic compounds and produce clean water.

The separation method used was pervaporation (negative pressure).

The ozone used as the oxidizing gas was diffused through a porous steel membrane ensuring dissolution and mixture of the gas in the liquid.

Finally, phthalic acid (C₆H₄—COOH—COOK) (KHP) was used as a model pollutant for the invention evaluation tests.

Indeed, simple ozonation (without coupling, with separation) was compared with coupled ozonation with separation under the same experimental conditions:

[O3]=100 g/m3

F_{O3}=10-11 Ml/min

[KHP]=0.53 g/L, equivalent to [TOC]=250 ppm carbon

T=40° C.

FIG. 2 provides a comparison of the organic compound (quantitatively measured by TOC) reduction performance with a reactor operating with ozonation/separation coupling and without ozonation/separation coupling.

For a liquid residence time of 3.3, 6.5 and 12.5 minutes, the TOC reduction percentage with respect to the initial amount was respectively 11, 25 and 66%, i.e. respective improvements of 34, 52 and 120% compared with non-coupled reactions under the same conditions.

In view of the results, it is clear that the coupling of ozonation with separation provides a non-negligible improvement.

Moreover, this improvement increases with the length of the residence time of the liquid in the reactor.

Indeed, the water production on the permeate side produces a concentration of organic compounds on the retentate side. This concentration results in an increase in the degradation kinetics of the organic compounds, dependent on it. This example clearly shows that the invention enables, by coupling the oxidation and the separation in a confined medium, synergy to be created between the two phenomena, resulting in a considerable improvement in the performance of oxidation of organic pollutants in solution.

Moreover, it should be noted that the filtered water produced, on the permeate side, does not contain more than 2 ppm of carbon for a supply containing up to 1000 ppm of carbon.

These results are remarkable inasmuch as they were obtained with inert membranes. Much better performances are expected if the membrane is active, i.e. catalytic or adsorbent.

1-17. (canceled)

18. A membrane reactor for treating water containing organic constituents comprising:
a reaction zone having a water inlet for introducing water into the reaction zone, the reaction zone disposed between first and second spaced apart membranes;
the first membrane separating the reaction zone from an oxidizing gas zone and permitting the oxidizing gas to flow through the first membrane into the reaction zone so that the oxidizing gas oxidizes the organic constituents in the water in the reaction zone;
the second membrane separating the reaction zone from a treated water zone and permitting water to flow through the second membrane into the treated water zone while retaining retentate in the reaction zone;
a retentate outlet operatively connected to the reaction zone; and
a treated water outlet operatively connected to the treated water zone.

19. The membrane reactor of claim 18 wherein the first membrane forms a first perimeter and the second membrane forms a second perimeter disposed within the first perimeter.

20. The membrane reactor of claim 18 wherein the first membrane forms a first perimeter and the second membrane forms a second perimeter, the first perimeter disposed within the second perimeter.

21. The membrane reactor of claim 18 wherein the first and second membranes are substantially concentric with respect to one another.

22. The membrane reactor of claim 18 wherein the first and second membranes are substantially planar and disposed substantially parallel to each other.

23. The membrane reactor of claim 18 wherein the first and second membranes form three separate zones; and wherein the separate zones include the oxidizing gas zone, the reaction zone, and the treated water zone.

24. The membrane reactor of claim 23 further comprising a third membrane for allowing treated water to flow from the second membrane into the treated water zone; and wherein the third membrane is disposed in a substantially concentric arrangement with the first and second membranes.

25. The membrane reactor of claim 23 further comprising a third membrane for allowing treated water to flow from the second membrane into the treated water zone; and
wherein the third membrane is disposed substantially parallel to the first and second membranes.

26. The membrane reactor of claim 18 wherein the second membrane is inert and formed from ozone resistant material.

27. The membrane reactor of claim 18 wherein the second membrane is a pervaporation membrane.

28. The membrane reactor of claim 18 wherein the second membrane is a reverse osmosis membrane.

29. The membrane reactor of claim 18 wherein the second membrane is an ultrafiltration, a microfiltration, or a nanofiltration membrane.

30. The membrane reactor of claim 18 wherein the second membrane has a layer of adsorbent material formed thereon.

31. The membrane reactor of claim 18 wherein the second membrane has a layer of catalyst formed thereon.

32. The membrane reactor of claim 18 further comprising a bed formed from adsorbent material and catalyst disposed in the reaction zone.

33. The membrane reactor of claim 18 wherein at least the reaction zone, the first membrane, the second membrane, and the treated water zone form a single module; and
wherein the system includes a plurality of modules disposed in series.

34. The membrane reactor of claim 18 wherein at least the reaction zone, the first membrane, the second membrane, and the treated water zone form a single module; and wherein the system includes a plurality of modules disposed in parallel.

35. The membrane reactor of claim 18 further comprising a thermocouple for measuring the temperature of the water in the reaction zone.

36. The membrane reactor of claim 18 wherein:
the organic constituents in the water in the reaction zone include phthalic acid;
the first membrane is a steel porous membrane for directing ozone into the reaction zone such that the ozone reacts with phthalic acid; and
the second membrane is a zeolite membrane disposed on a ceramic support for separating treated water from the organic constituents.

39. A method for treating water having organic constituents in a membrane reactor comprising:
directing water into a reaction zone disposed between a first and a second spaced apart membrane;
oxidizing organic constituents in the water by directing oxidizing gas through a first membrane into the reaction zone;
separating organic constituents from the water to form treated water and a retentate by directing the water from the reaction zone through a second membrane into a treated water zone while retaining the organic constituents in the reaction zone;
removing the retentate from the reaction zone; and
removing treated water from the treated water zone.

40. The method of claim 39 further comprising oxidizing the organic constituents in the reaction zone and separating the organic constituents from the water in the reaction zone simultaneously.

41. The method of claim 39 further comprising recirculating excess oxidizing gas in the reaction zone.

42. The method of claim 41 further comprising detecting excess oxidizing gas in the reaction zone and recirculating the excess oxidizing gas in the reaction zone.

43. The method of claim 40 further comprising:
directing water having up to approximately 1000 ppm of carbon into the reaction zone;
forming an oxidizing gas by directing peroxide or sodium persulfate through the first membrane to the water in the reaction zone;
directing the water from the reaction zone through the second membrane into an intermediate zone prior to directing the water to the treated water zone;
directing the water from the intermediate zone through a third membrane into the treated water zone;
removing carbon from the water such that the concentration of carbon in the treated water is reduced to approximately 2 ppm or less;
removing treated water having 2 ppm or less of carbon from the treated water zone; and
wherein the first and second membranes are concentrically oriented with respect to each other and the second membrane is a pervaporation membrane.

44. The method of claim 39 further comprising:
directing water having up to approximately 1000 ppm of carbon into the reaction zone; and
removing treated water having 2 ppm or less of carbon from the treated water zone.
